(19) United States
(12) Patent Application Publication
(10) Pub. No.: US 2014/0129305 A1
(43) Pub. Date: May 8, 2014

(54) SYSTEMS AND METHODS FOR SHOPPING OFFER CONTROL AND FEEDBACK

(71) Applicant: Makeena, LLC, Boulder, CO (US)

(72) Inventor: KAREN SHORESMAN FRAME, BOULDER, CO (US)

(73) Assignee: Makeena, LLC, Boulder, CO (US)

(21) Appl. No.: 14/071,081

(22) Filed: Nov. 4, 2013

Related U.S. Application Data
(60) Provisional application No. 61/722,031, filed on Nov. 2, 2012.

(51) Int. Cl. G06Q 30/02

(52) U.S. Cl. CPC G06Q 30/0211
USPC 705/14.13; 705/14.1

(57) ABSTRACT

Systems and methods for providing a brand owner direct control of offers redeemable by users. An exemplary system includes a user interface device, a processing device and a communication device. The processing device receives product information entered via a user interface device by a brand owner authorized user. The product information includes product name, product category and attribute information. The processing device also receives offer information entered via the user interface device by the brand owner authorized user, the offer information being associated with one or more products, wherein the offer information includes at least one product name, validity information, coding information, offer type information and associated store information. The processing device generates an offer(s) based on the received offer information. A communication device makes the generated offer(s) available to a user device-based application program.

### CROSS REFERENCE

This application claims the benefits of U.S. Provisional Application Ser. No. 61/722,031 filed Nov. 2, 2012, the contents of which are hereby incorporated by reference.

### FIELD OF THE INVENTION

The systems and methods described herein relate generally to controlling offers to consumers, customers, purchasers, shoppers, or users—these terms are used interchangeably throughout this application. More specifically, the systems and methods described herein relate to a network-based system for providing direct control of offers to consumers.

### BACKGROUND

Brand manufacturers that produce consumer products typically have no direct communication with customers. This is especially true for the natural products industry. Natural product brand owners typically do not have the resources to obtain full knowledge of marketing metrics. They may only know what distributer they are using. They may not know where their products are on the shelves or even where their products are sold (i.e., what region, state, city, etc.), or what stores they are sold in (e.g., Kroger®, Target®, Whole Foods®, Sprouts®, Safeway®, etc.). They also have no direct control over offers or coupons for their products.

### SUMMARY OF THE INVENTION

The present invention provides systems and methods for providing a brand owner direct control of offers redeemable by users. An exemplary system includes a user interface device, a processing device, and a communication device. The processing device receives product information entered via a user interface device by a brand owner authorized user. The product information includes product name, product category, and attribute information. The processing device also receives offer information entered via the user interface device by the brand owner authorized user, the offer information being associated with one or more products, wherein the offer information includes at least one product name, validity information, coding information, offer type information, and associated store information. The processing device generates an offer(s) based on the received offer information. A communication device makes the generated offer(s) available to a user device-based application program.

In one aspect of the invention, the communication device further receives offer interaction information from one or more of the user device-based application programs. The offer interaction information includes information of users interacting with each of the offers. The user interaction information includes user contact information, which allows for a direct connection or communication/interaction between a brand owner and the user.

In another aspect of the invention, the offer interaction information includes at least one of offer redemption information or selected offer information. The offer redemption information includes at least one of store information of where the offer was redeemed, date and time when the offer was redeemed and/or who redeemed the offer.

In still another aspect of the invention, the processing device is further configured to aggregate the offer interaction information received by the communication device and present the aggregated information via the user interface device.

In yet another aspect of the invention, a system includes memory that stores information of offers for at least one of a plurality of products or brands, information associating the offers with each of a plurality of stores, and information for the plurality of stores. The system also includes a user computer-based device, a location identification device that generates location information for the user device, and a processing device. The processing device receives the generated location information, identifies a store based on the received location information and the store information in the memory, and generates a sublist of offers based on the stored information of offers, and the information associating the offers with the identified store. An input/output device presents at least a portion of the generated sublist of offers to the user.

In still yet another aspect of the invention, the input/output device receives a selection of one or more offers and the processing device generates a sublist of the selected offers based on the information associating the offers with the identified store.

### BRIEF DESCRIPTION OF THE DRAWINGS

A further understanding of the nature and advantages of the inventive subject matter may be realized by reference to the remaining portions of the specification and the drawings, wherein like reference labels are used through the several drawings to refer to similar components.

FIG. 1A provides a schematic illustration of an infrastructure within which one or more embodiments of the inventive subject matter may operate;

FIG. 1B provides a schematic representation of a computer system that may be used to manage one or more embodiments of the inventive subject matter;

FIG. 2A is a flow diagram summarizing certain methods of the inventive subject matter;

FIG. 2B is a flow diagram summarizing other methods of the invention;

FIGS. 3 thru 9 are screen shots for an exemplary mobile device application formed in accordance with embodiments of the present invention;

FIGS. 10A-F are screen shots for an exemplary backend application formed in accordance with embodiments of the present invention; and

FIGS. 11 and 12 are flow diagrams summarizing certain methods of the inventive subject matter.

### DETAILED DESCRIPTION

Embodiments of the inventive subject matter provide methods and systems that enable the implementation of integrated shopping functions, including providing a consumer with immediate access to product information, managing coupons and other types of consumer rewards, generating shopping lists, managing recipe information, and the like.

In one embodiment, a user application program running on a user computer-based device enables a user to generate a products list (i.e., a whole shopping list or a part of a shopping list which contains only the offers) and automatically receive information (i.e., coupons, recipes, nutritional information, product ratings, product comparisons, etc.) for items on the list. This generated products list may be based on a manually or automatically selected store, region or predefined product attribute(s) (e.g., vegan, gluten-free, non-GMO, etc.). In other words, the products list may automatically edit itself based on selected store(s) information.

In another embodiment, a system enables brand owners to manage offers regarding their products directly to consumers. The system is able to identify people who interact with any of their products or redeem coupons associated with their products. Once a user is identified, the owner of the brands can provide other offers directly to the identified user.

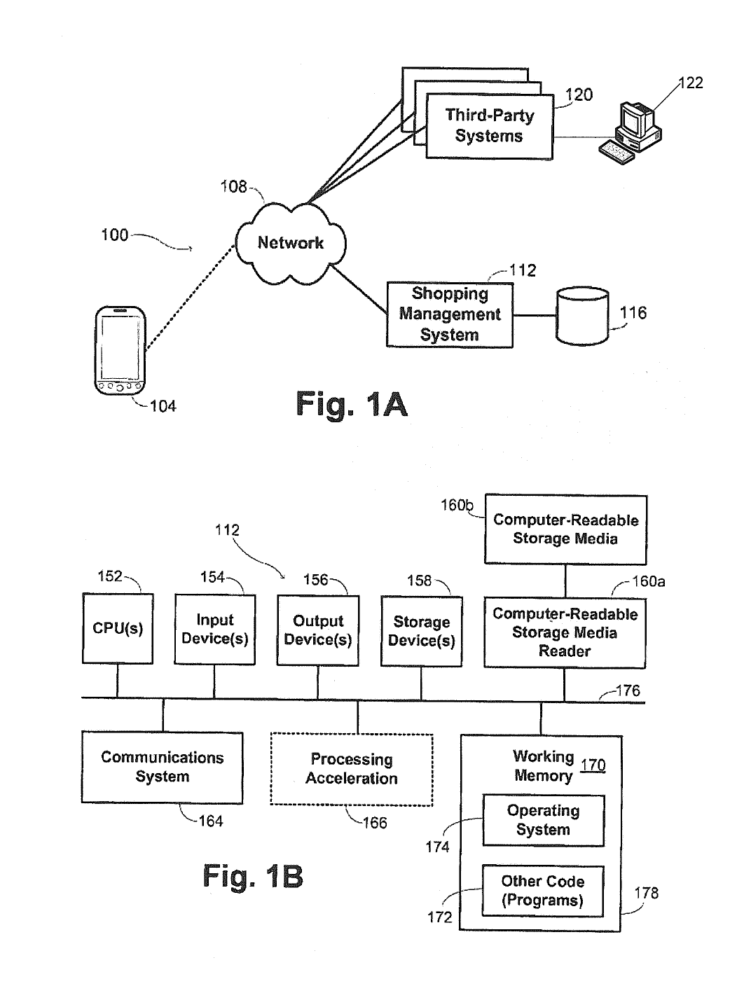

A general overview of an architecture for such an integrated system may be understood with reference to FIG. 1A, which provides a schematic illustration of different elements that may be included within such a system. The illustration of particular elements is intended to be illustrative rather than limiting. The architecture 100 is centered around a network 108 that is accessible by mobile devices 104. The network 108 may take any of a variety of forms depending on implementation, including the well-known 3G, 4G, and other mobile telecommunications networks as well as certain types of wi-fi networks and MD technologies. The use of different types of networks may depend on the particular environments in which embodiments of the invention are to be practiced, which may affect availability and cost of network access. The mobile devices 104 may take any of a variety of forms that are enabled with access to the network 108. For example, mobile devices may include mobile telephones, tablet computers, laptop computers, handheld game devices, personal digital assistants, enterprise digital assistants, portable media players, digital cameras, and the like.

The network 108 enables a mobile device 104 to engage in communications with a shopping management system 112 and to access data stored by the shopping management system at a data store 116. Additionally, the network 108 may enable communications to be effected between the shopping management system 112 and a number of third-party systems 120 in implementing the functionality described herein. Third-party systems 120 may include, for example, a variety of information sources (e.g., recipe and pricing databases, inventory systems), computational systems managed by product suppliers (e.g., brand owners), and the like. In alternative embodiments, communications between the third-party systems 120 and the shopping management system 112 may be effected in other ways, such as through direct connections or via one or more supplementary networks. The network 108 may usually include one or more public and/or private networks. Implementation of various encryption and security protocols may be effected by the network and/or by the shopping management system 112 and mobile device 104 in maintaining security of exchanged data. An exemplary third-party system 120 includes a computer 122 that includes user interface devices (e.g., mouse, keyboard, display, etc.), a processor, a communications device (e.g., modem with connection to the Internet), and a storage device.

An example structure for the shopping management system 112 is shown in FIG. 1B, although other structures may be used in alternative embodiments. The arrangement shown in FIG. 1B broadly illustrates how individual system elements may be implemented in a separated or more integrated manner. The shopping management system 112 is shown with hardware elements that are electrically coupled via a bus 176. The hardware elements can include a processor 152, an input device 154, an output device 156, a storage device 158, a computer-readable storage media reader 160a, a communications system 164, an optional processing acceleration unit 166 such as a digital-signal processor or special-purpose processor, and a memory 168. The computer-readable storage media reader 160a is further connected with a computer-readable storage medium 160b, the combination comprehensively representing remote, local, fixed, and/or removable storage devices plus storage media for temporarily and/or more permanently containing computer-readable information. The communications system 164 may include a wired, wireless, modem, and/or other type of interfacing connection that permits data to be exchanged via the network 108.

The shopping management system 112 also includes software elements, shown as being currently located within working memory 170, including an operating system 174 and another code 172, such as a program designed to implement methods of the invention. Substantial variations may be used herein in accordance with specific requirements. For example, customized hardware might also be used and/or particular elements might be implemented in hardware, software (including portable software such as applets), or both. Further, connection to other computing devices such as network input/output devices may be employed. The software components of the system 112 may be distributed amongst various locations across the network 108 (i.e., multiple hardware components remotely located from each other).

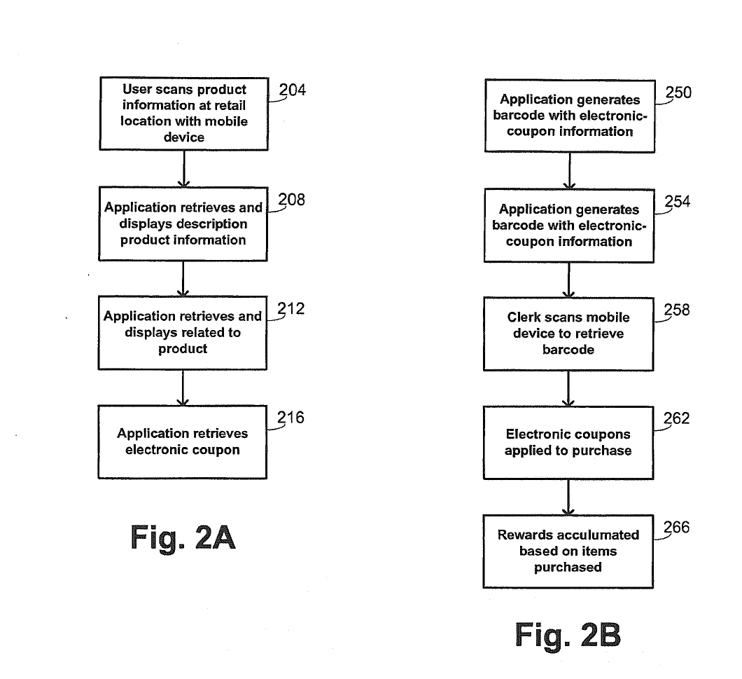

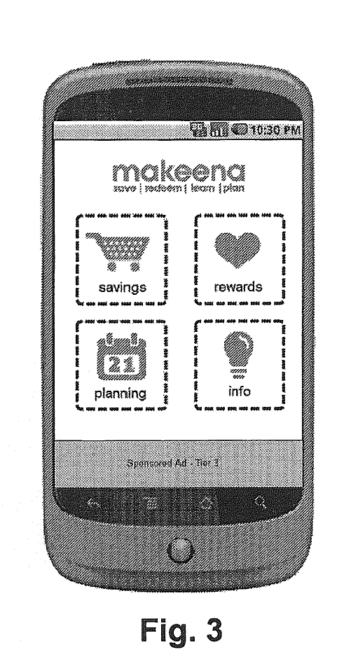

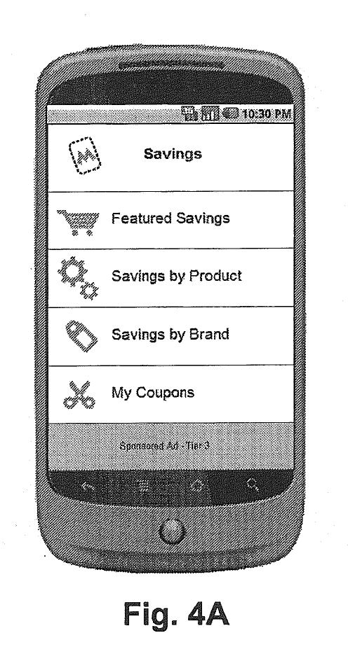

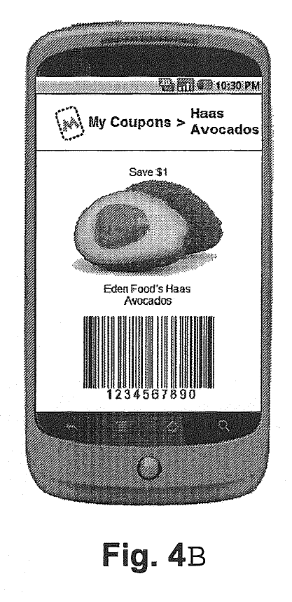

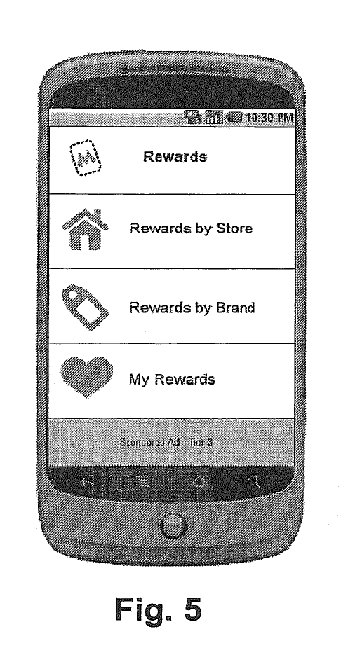

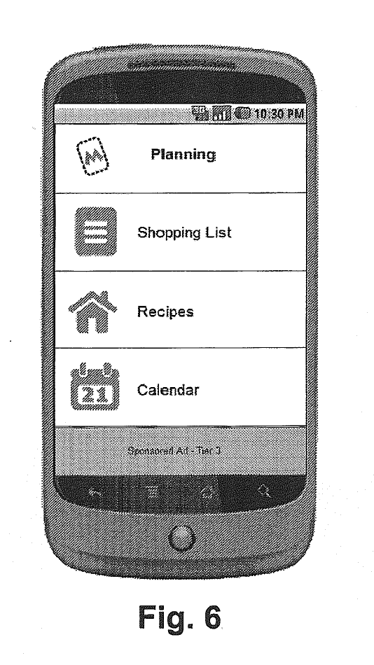

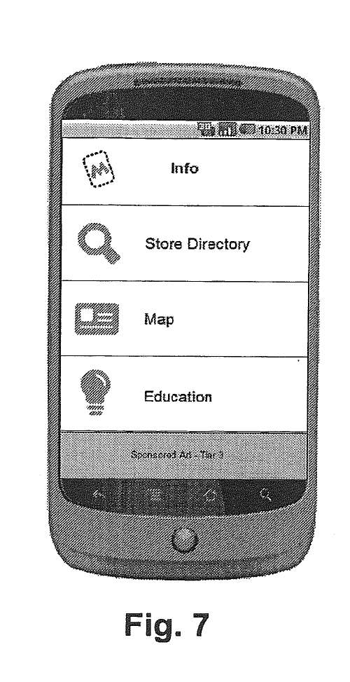

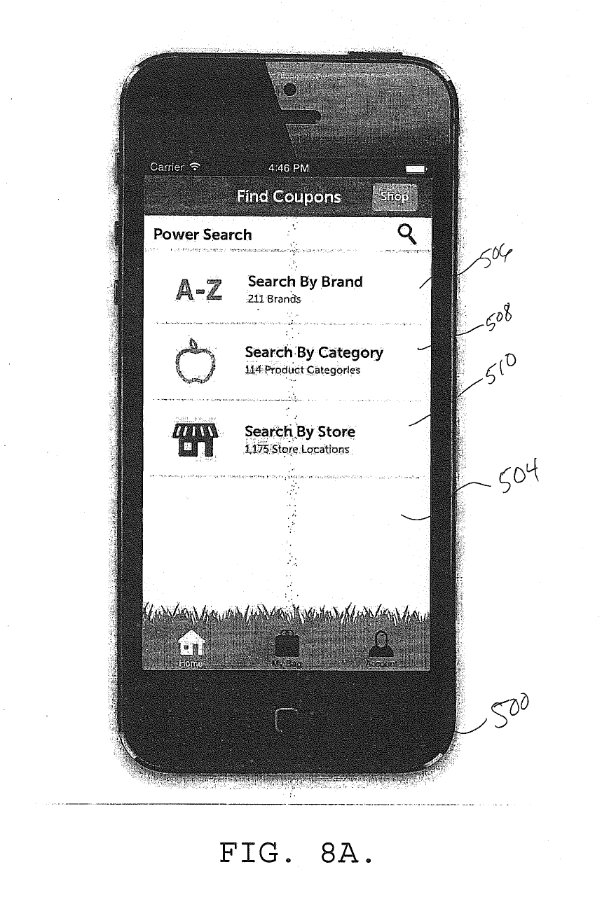

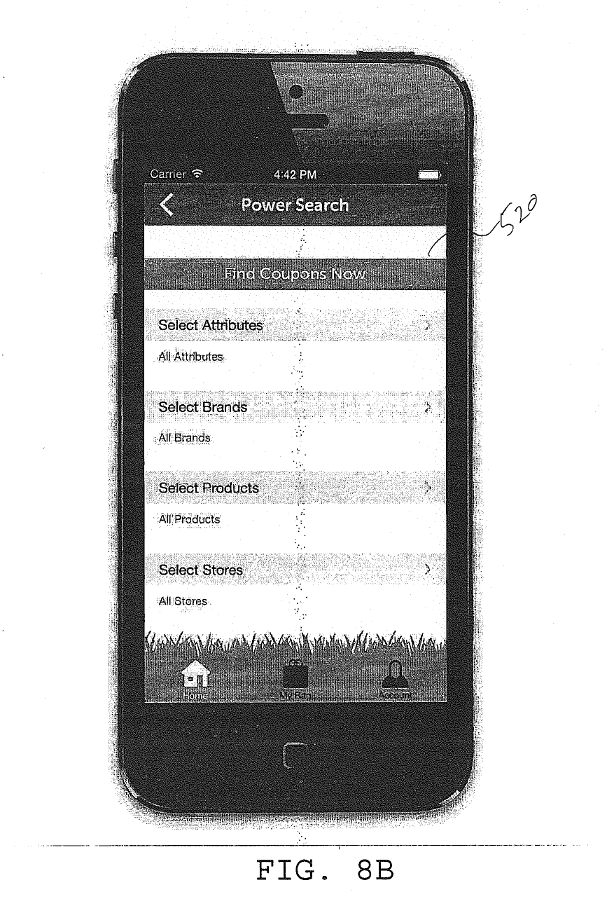

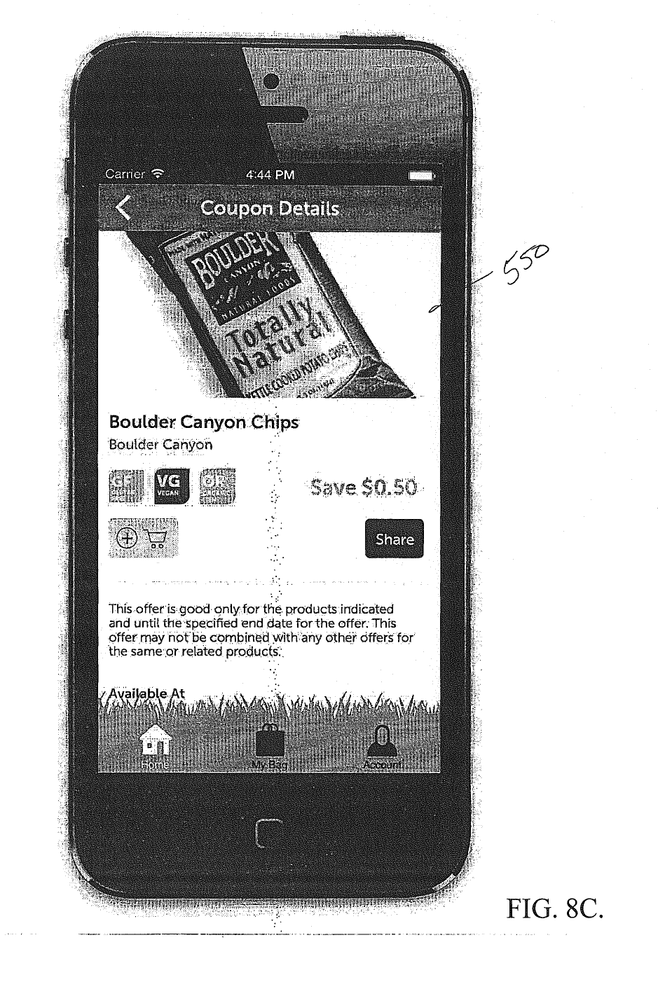

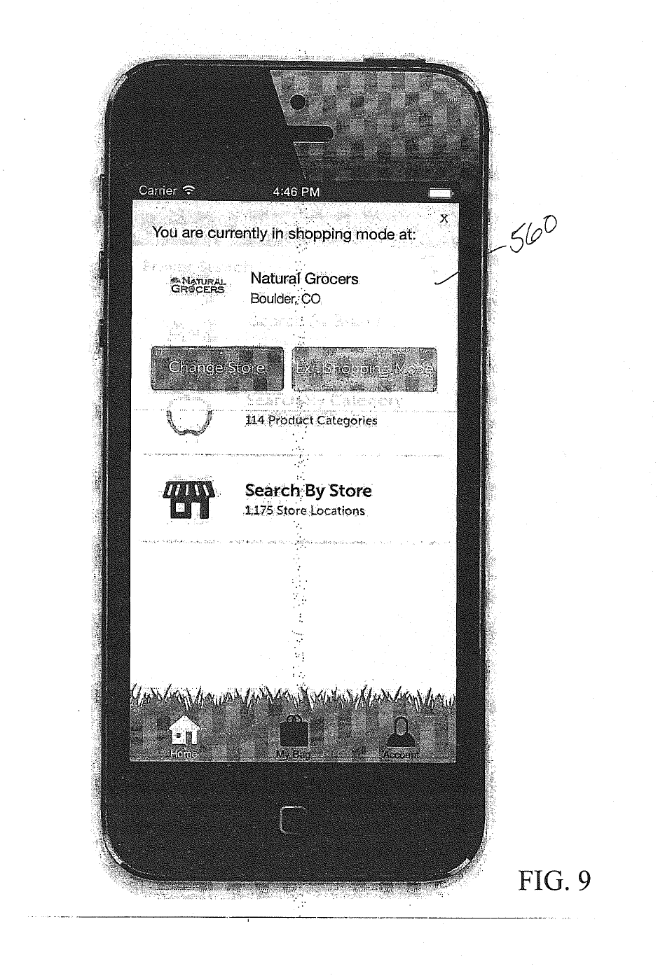

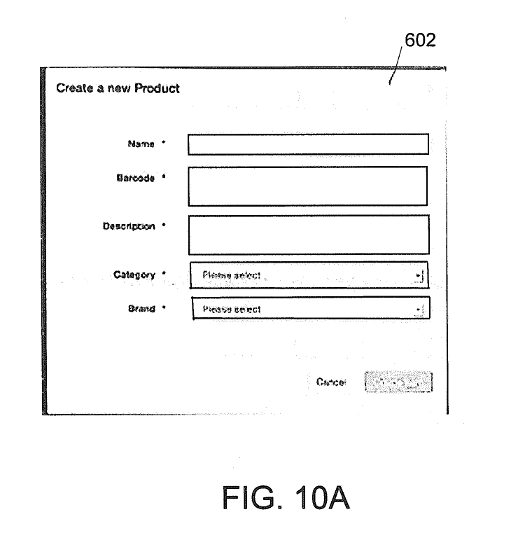

FIGS. 2A and 2B provide flow diagrams that summarize certain aspects of the inventive subject matter, which are further illustrated in greater detail in the screen shots of FIGS. 3-7F. For example, FIG. 2A provides a flow diagram illustrating use of the mobile-device shopping application as embodied on a mobile device 104 to retrieve information related to products at a retail location. As indicated at block 204, a user of the shopping application may scan product information at a retail outlet with the mobile device 104. Such scanning may occur in different ways in different embodiments. In many instances, products may be identified with labels that include identification barcodes in compliance with the Universal Product Code (“UPC”) or Global Trade Item Numbers (“GTIN”) symbologies, or with other product-identification symbologies. In such cases, scanning at block 204 may take place by using an optical reader included in the mobile device 104 to scan the barcode or other symbology. While the UPC and GTIN symbologies generally make use of one-dimensional barcode symbologies, the invention is not limited to such symbologies and may more generally be implemented to scan any known one-dimensional, two-dimensional, or color barcode symbologies, including the Codabar, Code 11, Code 128, Code 32, Code 39, Code 93, EAN-13, EAN-8, EAN-99, EAN-Velocity, Industrial 2 of 5, Interleaved 2 of %, ISBN, UPC-A, UPC-E, Aztec Code, Code 16K, PDF417, Compact PDF417, Micro PDF417, Macro PDF417, DataMatrix, QR Code, Semacode, and High Capacity Color Barcode (“HCCB”) symbologies, among others. In other cases, the mobile device may scan product information at block 204 by implementing optical character-recognition (“OCR”) techniques to read human-readable textual labels that identify product information. Additionally or alternatively, the mobile device 104 may acquire an image of a product, such as by taking a photograph of the product using a camera integrated with the mobile device, and therefrom determine the product information (e.g., the name of the product, the type of product, the size of the product, and the like) from a database, table, listing, or other logical construct that associates product images with product information.

Irrespective of whether the mobile device is configured to read either (or both) human-readable or machine-readable labels, such labels may be provided in a variety of ways. For example, labels may be printed directly on the products themselves, may be printed on packaging for the product, or may be printed on labels affixed to shelves on which products are displayed.

At block 208, the shopping application retrieves and displays descriptive product information. Retrieval of the information may be effected by establishing a communication over the network 108 between the mobile device 104 and the shopping management system 112, which coordinates retrieval of information from a local data store 116 or by further communication with the third-party systems 120. In some instances, information about products may previously have been downloaded directly to the mobile device 104 from the shopping management system 112 and stored locally on the mobile device 104. In such cases, information retrieval at block 208 may be performed as a purely local operation.

The information retrieved from the local data store 116 and/or from third-party systems 120 in response to the product information acquired by the mobile device 104 may be presented in a variety of manners to assist a user of the mobile device 104 in shopping for products. The product information obtained by the mobile device 104 can be used by the local data store 116 and/or third-party systems 120 to identify coupons or other discounts that can be used in purchasing the product with which the product information is associated. In one embodiment, the offers (e.g., coupons, discounts, or loyalty program benefits) can be used to increase sales of the product by offering a discount on a greater amount of the same product (that presumably costs more than the scanned product, even with the coupon or discount being applied). Additionally or alternatively, advertisements or recommendations for another, similar product may be provided from the data store 116 and/or third-party systems 120 in response to the product information being acquired from the product. Merely by way of illustration, examples include providing a recommendation for a competitor product, a more natural or organic product in the case of food products, a less expensive product, or the like.

Additional information can be acquired from the local data store 116 and/or third-party systems 120 in response to the product information being acquired. For example, recipes that include the product from which the product information was acquired may be presented to the user of the mobile device 104. Such recipes can recommend additional products that are made or sold by the same entity that supplied or provided the product from which the product information was acquired in order to drive additional sales to the same entity. The information from the local data store 116 and/or third-party systems 120 can include nutritional information of the product from which the product information was acquired. Additionally or alternatively, the local data store 116 and/or the third-party systems 120 can provide competitive nutritional or pricing information. For example, if a first product that is scanned by the mobile device 104 has poorer nutritional information relative to a competitive product (e.g., a scanned bag of potato chips has much more fat, salt, and/or carbohydrates than a competitive bag of baked pita chips), then the local data store 116 and/or third-party systems 120 can provide information on the competitive product to the mobile device 104.

The type of product information retrieved and displayed at block 208 may vary in different embodiments. Examples of descriptive information in the particular case of food products include a description of the product, nutritional information in the form of values for such qualities as caloric, fat, carbohydrate, protein, cholesterol, sodium, sugar, vitamin, and other content. Depending on the embodiment, other descriptive information might include product ratings from any of various ratings sources, alerts related to product recalls, product expiration dates, and the like.

At block 208, the shopping application may additionally retrieve and display recipes that make use of the product. Such recipe information advantageously enables the shopper to consider possible uses of the product before purchase, and perhaps to identify other products to purchase during the same shopping visit to be used with a desirable recipe.

At block 212, the shopping application may also retrieve electronic coupons that may be available for the product, and which can then be applied to the purchase of the product as described in connection with FIG. 2B. Consumers are frequently unaware of the full range of coupons that product suppliers make available, but advantageously have easy access to all such coupons by exploiting the connections the shopping management system 112 makes with third-party systems 120 to identify relevant coupons.

After the shopper has completed collecting items, informed by the various pieces of information provided by the shopping application, the methods summarized by FIG. 2B may be used to complete a purchase. As indicated at block 254, the shopping application generates one or more barcodes that encode relevant electronic-coupon information that may be scanned by a clerk or by the user at a checkout station at block 258. The electronic-coupon information may include electronic coupons retrieved at block 216 of FIG. 2A and/or may include electronic-coupon information previously downloaded to the mobile device 104. The electronic coupons are accordingly applied to the purchase at block 262.

As indicated at block 266, rewards may also be accumulated based on the items actually purchased. Such rewards may be managed by the shopping application for a variety of different kinds of rewards or loyalty programs. For example, the rewards may be accumulated for programs that are associated with the company that manages the particular store at which products are purchased, may be accumulated for programs that are associated with particular product suppliers, may be accumulated for programs that are associated with particular products, may be accumulated for programs associated with particular modes of payment such as credit-card rewards programs, and the like. The inconvenience of some rewards or loyalty programs can be overcome by the consolidation achieved by the shopping application described herein.

FIGS. 3-9 provide illustrations of screen shows that illustrate a variety of other features achieved by the consolidation of functionalities implemented by the shopping application. FIG. 3, for instance, provides an illustration of a home screen that shows one potential organization of the different functionalities: “Savings,” “Rewards,” “Planning,” and “Info[rmation].”

A “Savings” home screen shown in FIG. 4A, accessed from the graphical user interface (GUI) of FIG. 3, includes its own organization that shows links to featured savings, savings by product, savings by brand, and coupons maintained by the shopping application on behalf of a particular user. The featured savings screen includes information that may be provided for bargains that the shopping application features, such as in response to payment for promoting the bargain as a feature by the producer of the featured product or by the store where it is available. In addition to describing the featured product and the bargain being promoted, the screen may include links to possible recipes where the product may be used and an indication of where the product may be found within the store. A share button allows the user to share the coupon or announce that the user likes this product or brand to any number of social networks.

A products screen, accessed from the GUI of FIG. 4A, provides an organization of different products to enable a user to readily locate savings information about particular products. That information details the different products for which bargains are available, the cost of the products, and the savings available.

A brand screen, accessed from the GUI of FIG. 4A, provides a different organization of the product savings information, organized instead by brand. The brand screen provides details about the specific products, their cost, and available savings. The brand screen may be organized by product name, price, or savings amount.

A coupons screen, accessed from the GUI of FIG. 4A, summarizes the different electronic coupons already available on the mobile device 104. They may have been downloaded automatically by the shopping management system 112, perhaps in accordance with predefined criteria entered by the user, in accordance with the user's shopping history, or in accordance with other criteria. The exemplary screen shot of FIG. 4B shows how an electronic coupon may be rendered for presentation to a clerk, including both human-readable text and barcode information amenable to easy scanning.

A “Rewards” screen of FIG. 5, accessed from the GUI of FIG. 3, allows for various available rewards to be located by a user in different ways—by store, by brand. Store rewards are shown to the user with both summary information that highlights the value of rewards accumulated over different time periods, as well as an indication of progress towards future rewards. A redemption button allows user to redeem the award, thereby converting it into a coupon that can be spent at the store when desirable. A brand rewards screen/GUI includes similar summary and progress information, as well as a mechanism for redeeming accumulated rewards associated with a particular brand.

Various formats may be used for presentation of electronic coupons. The coupons may be organized by store or by brand. One or two-dimensional barcodes may be shown on the user interface for scanning by a cashier or the user during checkout.

A screen shot of a “Planning” GUI, accessed from the GUI of FIG. 3, is shown in FIG. 6. The planning GUI shows one way in which the shopping application may organize planning information, specifically by including a shopping-list GUI, a recipes GUI, and a calendar GUI.

Shopping lists are presentable in a variety of formats for allowing a user intermediate-level organization, thus allowing for multiple different lists to be maintained. This is useful for purposes of creating shopping lists associated with different stores, associated with different events, or associated with different personal activities. A new shopping list may be created at an input screen, which allows the list to be named and added to a user's calendar. Alternately, the shopping list is generated by the user entering the list into the system through their home computer or scanned via their mobile device. The user may add to their shopping list by using their mobile or similar device to scan products anywhere (at home, in the store, etc.)

In one embodiment, recipes are shown and organized as featured recipes or personal recipes. Featured recipes are those that the software application 112 highlights, perhaps to support particular product suppliers or in response to recorded user buying patterns. The personal recipes are those the user has specifically chosen to maintain. A featured recipe may be added to the list of personal recipes with activation of a user interface on-screen button. New personal recipes may be added through other GUIs.

A calendar feature allows shopping dates to be planned and may be coordinated with specific shopping lists.

An “Info” screen of FIG. 7, accessed from the GUI of FIG. 3, provides information such as store directory information, a map function, and educational information. Store directory information may be organized for accessibility by product or by brand and alternately including location information of products/brands within the store. The map function allows the user to access a map showing the location of stores and perhaps also to provide route information from specified locations. The educational information provides an index that may be accessed to provide textual and graphic information about certain products.

With the various functional aspects of the shopping application, a user is thus provided with a mechanism for organizing savings programs and rewards, for executing a variety of different planning functions, and for accessing educational information about products.

Iterative Filtering

In one embodiment, as shown in FIGS. 8A-C, users use an iterative search GUI in order to provide a search field for narrowing down the list of items (coupons, discounts) that are presented to them or narrowing down a general shopping list based on where the user is or will be shopping. This GUI is hosted by the shopping management system 112 or downloadable as an app to a user's mobile device or other computing platform. In one embodiment, if the list is small it is stored on the mobile device, otherwise the list is hosted by the shopping management system 112. For larger lists iterative searching is performed in conjunction with the server (the system 112).

FIG. 8A shows a mobile device 500 that presents a power search GUI 504. The power search GUI 504 includes links 506, 508, 510 that provide other GUI pages that allow a user to narrow the coupon search according to brands, product categories, and stores (or store location).

FIG. 8B shows a GUI 520 that allows a user to further limit a coupon search by accessing other GUIs that allow a user to select from various attributes, brands, specific products, or stores. An attribute selection GUI allows a user to select/filter coupons based on one or more attributes. Exemplary attributes include gluten free, lactose free, locally grown, low fat, organic, vegan, or vegetarian. These attributes are previously assigned to products directly by the brand or by operator of the shopping management system 112. A brand GUI allows a user to limit a coupon search by selecting one or more brands from a previously defined list of brands. A product type GUI allows a user to filter coupons by a product type (category or subcategory) selection.

A store selection GUI allows a user to select which store(s) they prefer the search for coupons/offers to be limited to. Coupons and offers have previously assigned stores. This previously assigned store information is provided by the operator of the shopping management system 112, operators of the stores, the brand owner, or from information received via user devices during shopping mode operation.

A Find Coupons Now button located in the GUI 520 finds coupons based on the limitations (attributes, brand, product type, or store(s)) the user selected. Presented coupons allow the user to add the coupon to their coupon list, allow the user to share the coupon or allow the user to indicate that they like this product/coupon with one or more of their previously designated social networks. The presented coupon also indicates the associated attributes—see FIG. 8C

A redeem coupon GUI displays coupon/offer codes (e.g., barcodes according to one of a number of known coupon barcode standards) that have been filtered and selected by the user based on the entries into the GUI 520. When the user checks out of a store they scan their mobile device with the displayed coupons or hand the mobile device to the cashier for scanning and redeeming.

FIG. 9 shows an exemplary shopping mode GUI 560 presented on the user mobile device 104. The GUI 560 allows a user to exit the shopping mode or change stores.

In one embodiment, when the user mobile device portion of the shopping management system 112 has switched to shopping mode after a user has already generated and saved a shopping list or a coupon or offer list (see FIGS. 4-8C), the list is automatically filtered according to the store selected or the store where the user is currently located. In one embodiment, this filter begins after the shopping mode has been automatically or manually selected. Automatic store or shopping mode selection is performed by the mobile device receiving mobile device position information (from an position sensor within the device) then comparing that to predefined position information for stores included in the list of stores. In one embodiment, the store or shopping mode selection occurs once the mobile device is within a threshold distance of a location associated with a store.

Once a store/shopping mode is selected, any coupon or product in coupon/shopping list that is not carried by the currently identified store is removed from the respective list.

In one embodiment, a list of stores with the name of the store and optional position information (e.g., latitude/longitude) is returned. The list of stores may be filtered based on a threshold distance from a current location of the mobile device 104. In one embodiment, the values represent the longitude and latitude near which store locations are requested along with the radius within which returned stores are included in the result set. The results are ordered by store name if no location is supplied. If location is supplied, the stores are sorted by distance from the specified location (mobile device location or user selected location).

In one embodiment, a shopping cart id is assigned to the user either before or during shopping mode activation. The shopping cart id is linked to all the coupons/offers that the user has previously selected and that have been verified to be applicable to the currently selected store. Thus, when the user checks out of the store, all that gets scanned at check out is the shopping cart id (e.g., barcode, QR code, etc.). The check out system contacts the shopping management system 112. The shopping management system 112 finds all the coupons/offers the user previously selected from storage 116 based on the shopping cart id. The found coupons/offers are returned to the check out system which applies the appropriate discount or savings.

In another embodiment, after the user has checked out, they scan their shopping receipt. The scanned shopping receipt is parsed and compared to all the coupons/offers in the user's stored list of coupons/offers. If matches between the parsed shopping receipt and the list of coupons/offers are found, then the shopping management system 112 applies a monetary credit/award to the user's account. This avoids having the brand to negotiate the use of their coupons with every store.

In one embodiment, the state of the shopping list to the specified state is set. The state is used as part of the workflow for the user who initially creates a shopping list, then adds an item to her cart, checks out items from the cart, and, finally, selects “done shopping”. The states that the cart can be placed into include “list”, “cart”, “checkout”, and “done”.

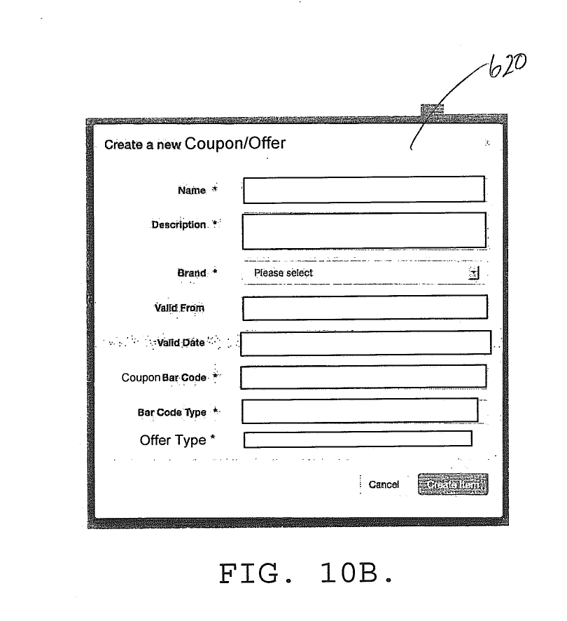

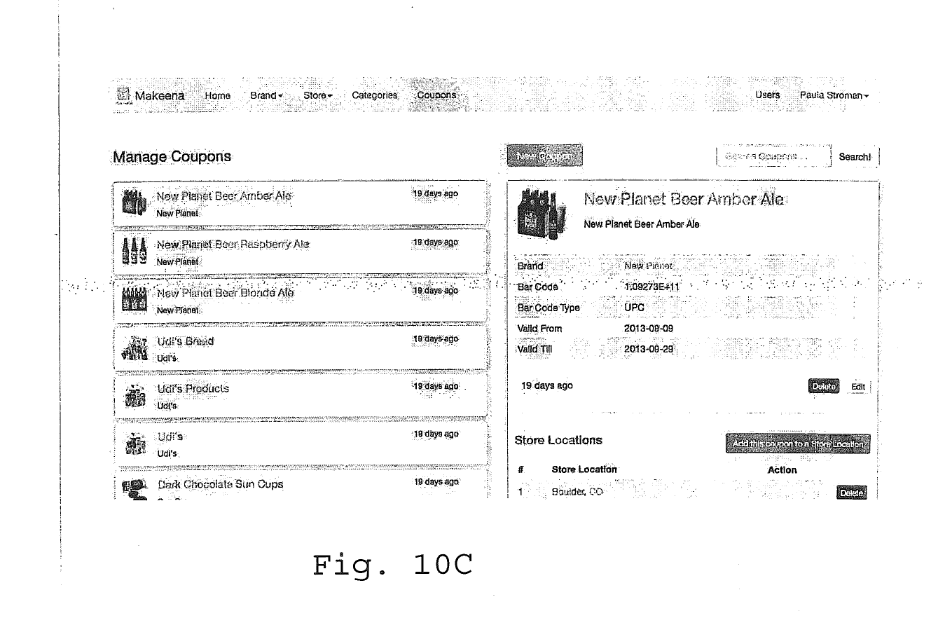

FIGS. 10A-F show an exemplary set of GUIs that allow brand manufacturers that produce consumer products to have direct communication with customers. Typically, natural product brand owners do not have the resources to obtain full knowledge of marketing metrics. They may only know what distributer they are using. They may not know where their products are on the shelves or even where their products are sold. They also have no direct control over offers or coupons for their products.

As shown in FIGS. 10A-F, a set of GUIs are shown that allow a brand owner/manufacturer to directly control distribution of coupons for their products. FIG. 10A shows a GUI 602 that allows the brand owner/manufacturer to choose or enter new products into the system hosted by the shopping management system 112. These products may have coupons assigned to them in the future. The GUI 602, includes product name, id code (e.g., barcode), description, category, attributes, and brand fields for receiving information from the brand manufacturer. The fields of the GUI 602 may accept text entered via a text entry system or from an automated system (e.g., scanning barcode, QR) which retrieves associated information from a products' database stored at the data store 116 or at a database hosted by the third-party system 120. Other information is entered into fields from a selection from a predefined list included in a pull-down or comparable menu. Other information fields (not show) may include contact person, address for billing purposes, related phone numbers, website URL, or related social network information.

FIG. 10B shows an exemplary coupon/offer creation GUI 620 that allows the manufacturer to create a coupon for a product or an offer for a product, entire brand, or subset of products. The GUI 620 includes the following exemplary fields for receiving manufacturer supplied information: name, description, brand (may be defaulted if brand owner has logged into a specific brand), validity dates, coupon code (e.g., barcode), code type (e.g., coupon barcode), offer type, and add product(s). The offer type is selected from a previously defined list of types—ex. amount of money off; percent discount; buy 1 get x free; two for one. The offer types may be configurable by the brand owner/manufacturer or the operator of the shopping management system 112. The GUI 620 may also include fields for allowing a brand owner to enter how much ($) to offer each customer, how many they want to offer to customers, how many offers available for a particular store, chain or region (e.g., city, state, region), of stores to customers where and when they want to the offer to be valid (i.e., what stores, time of year, expiration of offers, etc.), and whether they want to set up a loyalty program for their brand and how they want to structure the loyalty program.

FIG. 10C shows an exemplary GUI that allows a brand owner/manufacturer or the operator of the shopping management system 112 to add/edit coupons. This example shows many coupons from multiple brands. The brand owner/manufacturer would only be able to edit only their coupons/offers. A displayed coupon shows the previously entered information along with store locations where coupon is redeemable. The user may add other store locations via this GUI and may edit the coupon itself.

FIGS. 10D-F show exemplary GUIs that allow a brand owner/manufacturer or the operator of the shopping management system 112 to add/edit store information. A manufacturer, store representative, or operator of the shopping management system 112 is able through these GUIs to enter store names and location in associated fields. The user of these GUIs may also enter a location (lat/long or city name), then the application searches a database of stores for all stores located at the entered location or a threshold distance from the entered location. The database of stores may be part of a master list of businesses such as that used in mapping systems. This master list of businesses is filtered according to predefined categories (e.g., grocery, clothing, etc.) In one embodiment, the category is defaulted to grocery, thus limiting the businesses accordingly.

Other GUIs allow a brand owner/manufacturer to add users that are authorized to operate the GUIs shown in FIGS. 10A-F. Exemplary users may include brand managers, product managers, or coupon managers. This allows the brand owner/manufacturer to assign direct responsibility of coupon/offer control to those who have direct responsibility for the associated product.

Other GUIs allow a brand owner/manufacturer or the operator of the shopping management system 112 to add new product attributes (described above with FIG. 8B), add and edit brand information, and/or add/edit product categories or subcategories.

The brand owner/manufacturer operating the third-party system 120 receives various forms and quantity of coupon/offer/consumer feedback information. In one embodiment, the user application program collects various information of the user's interaction with the shopping management system 112. User interaction with the user application program includes selecting products for a shopping list, scanning products, viewing or selecting coupons/offers, or viewing brands/products. Any of these user interactions are saved then sent either directly to the associated third-party system 120 or to the shopping management system 112 that allows the brand owner/manufacturer to view via access to the shopping management system website. The user interaction information is presentable in various reports or formats.

In one embodiment, the brand owner/manufacturer has the ability to send offers to users that have purchased their products. The specific user information may be held secret at the shopping management system 112, thus the brand owner/manufacturer does not have access to direct personal user information unless the user provides that access. This allows the brand owner/manufacturer to get direct feedback from consumers and to provide offers directly to those users they know like or use their products.

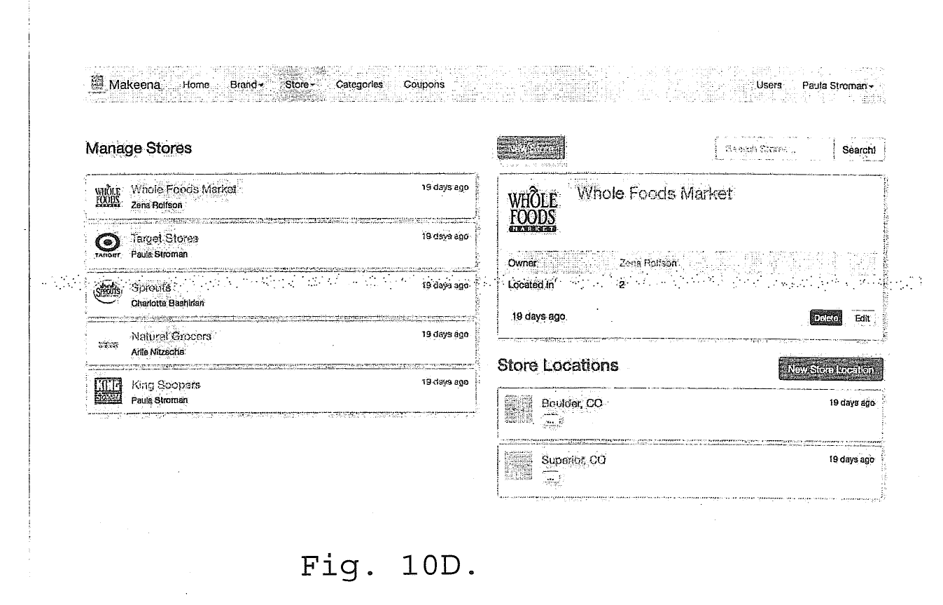

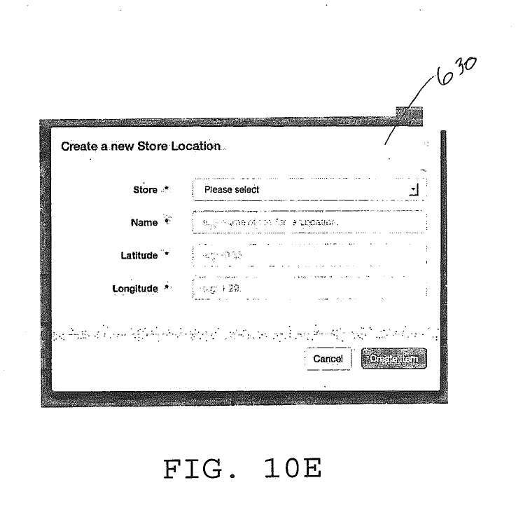

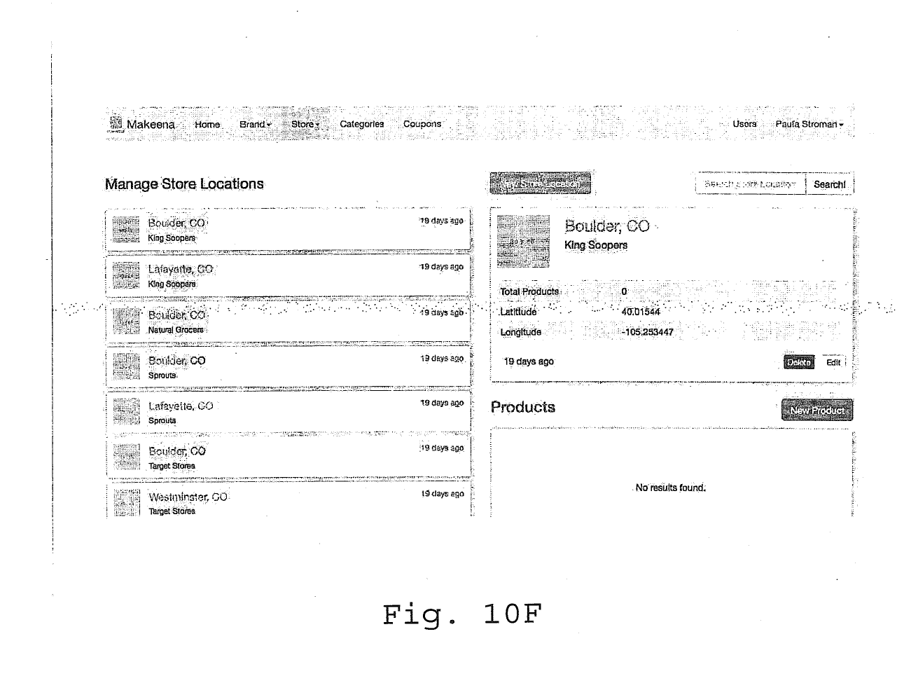

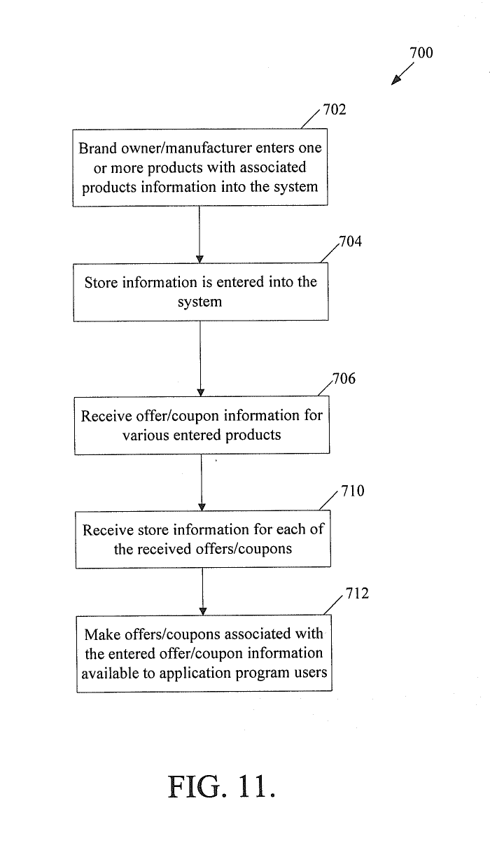

FIG. 11 shows and exemplary process 700 performed by the components of the system shown in FIG. 1A. First, at a block 702, a brand owner/manufacturer enters one or more products with associated products information into the system using an application program accessed via the system 122. The application program is hosted or produced by the shopping management system 112. At a block 704, store information is entered into the system using the application program through a web browser. Next, at a block 706, the brand owner/manufacturer enters offer/coupon information for various ones of the entered products. Then, at a block 710, the brand owner/manufacturer associates various stores with each of the entered offer/coupon information. At a block 712, the system makes offers/coupons available to consumers according to the information entered by the brand owner/manufacturer.

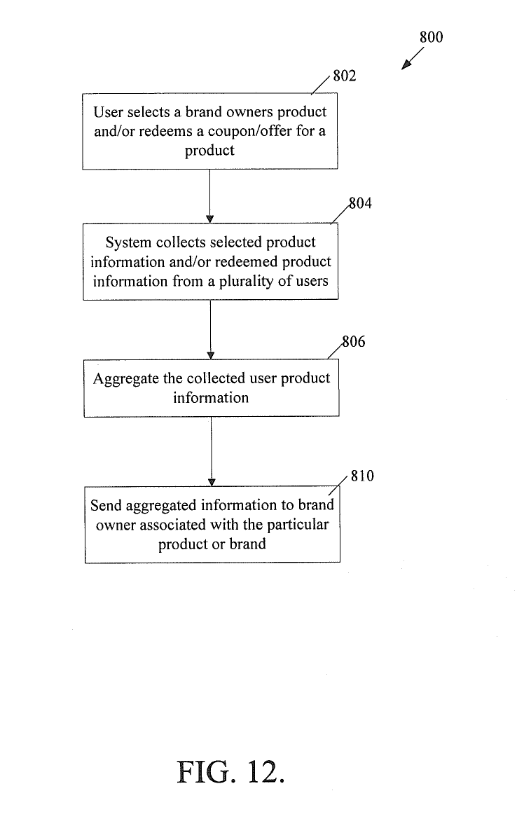

FIG. 12 shows and exemplary process 800 that provides feedback to brand owners. First, at a block 802, the user/consumer selects a brand owner's product and/or redeems a coupon/offer for a product using their device 104. Then, at a block 804, the system 112 collects the selected product information and/or the redeemed product information from a plurality of users. The selected product information and/or the redeemed product information may include information about how the offer was redeemed (e.g., at store, through website, etc.) and/or why the offer was redeemed. Information about why an offer was redeemed may include an initiating event, such as selection of offer from a recipe or when a product pairing is presented to the user. A product pairing occurs when the system 112 provides a recommendation of other product(s) offers based upon an already selected product/offer. At a block 806, the system 112 aggregates the collected user product information. Then, at a block 810, the system 112 makes the aggregated information available to the brand owner associated with the particular product or brand.

Having described several embodiments, it will be recognized by those of skill in the art that various modifications, alternative constructions, and equivalents may be used without departing from the spirit of the inventive subject matter. Accordingly, the above description should not be taken as limiting the scope of the inventive subject matter, which is defined in the following claims.

What is claimed is:

1. A system for providing a brand owner direct control of offers redeemable by users for brand owner products, the system comprising:
a user interface device;
a processing device in data communication with the user interface device, the processing device configured to:
receive product information entered via the user interface device by a brand owner authorized user, the product information comprising product name, product category, and attribute information;
receive offer information entered via the user interface device by the brand owner authorized user, the offer information being associated with one or more products, wherein the offer information comprises at least one of product name associated with previously received product information, validity information, coding information, offer type information and associated store information;
generate an offer based on the received offer information; and
a communication device in data communication with the processing device and a plurality of user devices via a network, the communication device configured to make the generated offer available to a user device-based application program.

2. The system of claim 1, wherein the communication device is further configured to receive offer interaction information from the user device-based application programs, the offer interaction information comprises information of users interacting with each of the offers.

3. The system of claim 2, wherein the offer interaction information comprises at least one of offer redemption information or offer selection information.

4. The system of claim 3, wherein the offer redemption information comprises at least one of store information of where the offer was redeemed, date and time when the offer was redeemed, how the offer was redeemed, or why the offer was redeemed.

5. The system of claim 4, wherein the processing device is further configured to generate a second offer based on the offer redemption information.

6. The system of claim 5, wherein the offer redemption information comprises contact information for the user who performed the offer redemption, wherein the communication device sends the generated second offer to the user who performed the offer redemption based on the contact information.

7. The system of claim 4, wherein the processing device is further configured to aggregate the offer interaction information received by the communication device and present the aggregated information via the user interface device.

8. A method for providing a brand owner direct control of offers redeemable by users for brand owner products, the method comprising:
at a processing device,
receiving product information entered via a user interface device by a brand owner authorized user, the product information comprising product name, product category, and attribute information;
receiving offer information entered via the user interface device by the brand owner authorized user, the offer information being associated with one or more products, wherein the offer information comprises at least one of product name associated with previously received product information, validity information, coding information, offer type information, and associated store information;
generating an offer based on the received offer information; and
at a communication device, making the generated offer available to a user device-based application program,
wherein the communication device is in data communication with the processing device and a plurality of user devices via a network.

9. The method of claim 8, further comprising receiving offer interaction information at the communication device from the user device-based application programs, the offer interaction information comprises information of users interacting with each of the offers.

10. The method of claim 9, wherein the offer interaction information comprises at least one of offer redemption information or offer selection information.

11. The method of claim 10, wherein the offer redemption information comprises at least one of store information of where the offer was redeemed, date and time when the offer was redeemed, how the offer was redeemed, or why the offer was redeemed.

12. The method of claim 11, further comprising at the processing device generating a second offer based on the offer redemption information.

13. The method of claim 12, wherein the offer redemption information comprises contact information for the user who performed the offer redemption, further comprising at the communication device sending the generated second offer to the user who performed the offer redemption based on the contact information.

14. The method of claim 13, further comprising:
at the processing device, aggregating the offer interaction information received by the communication device; and
presenting the aggregated information via the user interface device.

15. A system comprising:
memory configured to store information of offers for at least one of a plurality of products or brands, information associating the offers with each of a plurality of stores and information for the plurality of stores;
a user computer-based device comprising:
a location identification device configured to generate location information for the user device;
a processing device configured to:
receive the generated location information;
identify a store based on the received location information and the store information in the memory; and
generate a sublist of offers based on the stored information of offers and the information associating the offers with the identified store; and
an input/output device configured to present at least a portion of the generated sublist of offers.

16. The system of claim 15, wherein the input/output device configured to receive a selection of one or more offers, wherein the processing device is further configured to generate a second sublist of the selected offers based on the information associating the offers with the identified store, wherein the input/output device presents at least a portion of the generated second sublist.

17. The system of claim 15, wherein the memory is included in the user computer-based device.

18. The system of claim 15, further comprising a computer-based server being in data communication with the user computer-based device over a network connection, wherein the memory is included in the server.

19. A method comprising:
at a memory device, storing information of offers for at least one of a plurality of products or brands, information associating the offers with each of a plurality of stores, and information for the plurality of stores;
at user computer-based device,
at a location identification device, generating location information for the user device;
at a processing device,
receiving the generated location information;
identifying a store based on the received location information and the store information in the memory; and
generating a sublist of offers based on the stored information of offers and the information associating the offers with the identified store; and
at an input/output device, presenting at least a portion of the generated sublist of offers.

20. The method of claim 19, further comprising:
at the input/output device, receiving a selection of one or more offers;
at the processing device generating a second sublist of the selected offers based on the information associating the offers with the identified store,
at the input/output device, presenting at least a portion of the generated second sublist.

21. The method of claim 19, wherein the memory is included in the user computer-based device.
